(19) United States
(12) Patent Application Publication
(10) Pub. No.: US 2006/0262087 A1
(43) Pub. Date: Nov. 23, 2006

(54) Unified status support over USB and HTTP

(75) Inventors: Mark L. Hanson, Wilsonville, OR (US); Jonathan Edmonds, Wilsonville, OR (US)

Correspondence Address: Marger Johnson & McCollom, P.C., 1030 SW Morrison Street, Portland, OR, 97205, US

(73) Assignee: Xerox Corporation

(21) Appl. No.: 11/135,752

(22) Filed: May 23, 2005

(51) Int. Cl. G09G 5/00

(52) U.S. Cl. 345/156

(57) ABSTRACT

A device, such as a printer, can be connected to one or more computer systems along multiple communication media. In response to a message from one of the computer systems, the device generates a report. The report is generated in a manner that is independent of the communication medium over which the message is transported. The report is packaged for transport, and then transmitted along the appropriate communication medium back to the computer system.

### BACKGROUND

This invention pertains to providing a uniform response structure for device inquiries.

Historically, computer devices were attached to a single computer. For example, parallel printers were attached to a single computer via a parallel port. This meant that, when a user on a computer not directly connected to a device wanted to communicate with the device, the user had three choices: get a copy of the device installed on his computer, move to the computer where the device was attached, or transmit data across a network between the two computers, and request the computer to which the device was attached to communicate with the device.

While the last option was the most practical, in that it required neither a new copy of the device nor physical relocation by the user, it burdened the computer to which the device was connected. Because all communications with the device had to pass through that computer, that computer could spend a large chunk of its processing cycles managing the device, and not serving as a computer for its user.

To address this situation, device manufacturers moved to networked devices. Rather than being connected solely to one computer, the devices can now also be connected directly to the network. This solved the problem of the burden on the computer to which the device was connected: instead of that computer being burdened, the processing could all be handled by the computer that the user was using, regardless of the user's physical location.

But because direct connections still offer advantages over networked devices, such as security, rich status, and simplicity, these devices often are also connected directly to a computer. The device can then provide utility to the entire network, but still provide all of the normal advantages of being directly connected to the primary computer.

Because the ways the device can be connected to the computer and to the network differ, how computers communicate with the device depends on the specific connection path used. This means that computers and devices both must know how to communicate with the device along both communication media. Since the different communication media can use different protocols, this requires both computers and devices to know how to communicate using multiple protocols. In addition, different protocols provide different capabilities, meaning that the variety and quantity of information available via one protocol can differ from that offered using another protocol.

The invention addresses these problems and others in the art.

### SUMMARY

An apparatus, such as a printer, can have multiple connectors that can be connected to multiple communication media. A communications manager can receive a message over one of the communication media. The message is forwarded to a report generator, which generates a report responsive to the message. The report generated is independent of the communication medium over which the message was received. The report is then packaged for transport over the communication medium, and transmitted back to the sender.

### BRIEF DESCRIPTION OF THE DRAWINGS

FIG. 1 shows a computer system and a device communicating via multiple communication media, according to an embodiment.

FIG. 2 shows detail of the device of FIG. 1.

FIG. 3 shows detail of the connection manager of FIG. 2, in the device of FIG. 1.

FIG. 4 shows a flowchart of the procedure for communicating between the computer system and the device of FIG. 1.

### DETAILED DESCRIPTION

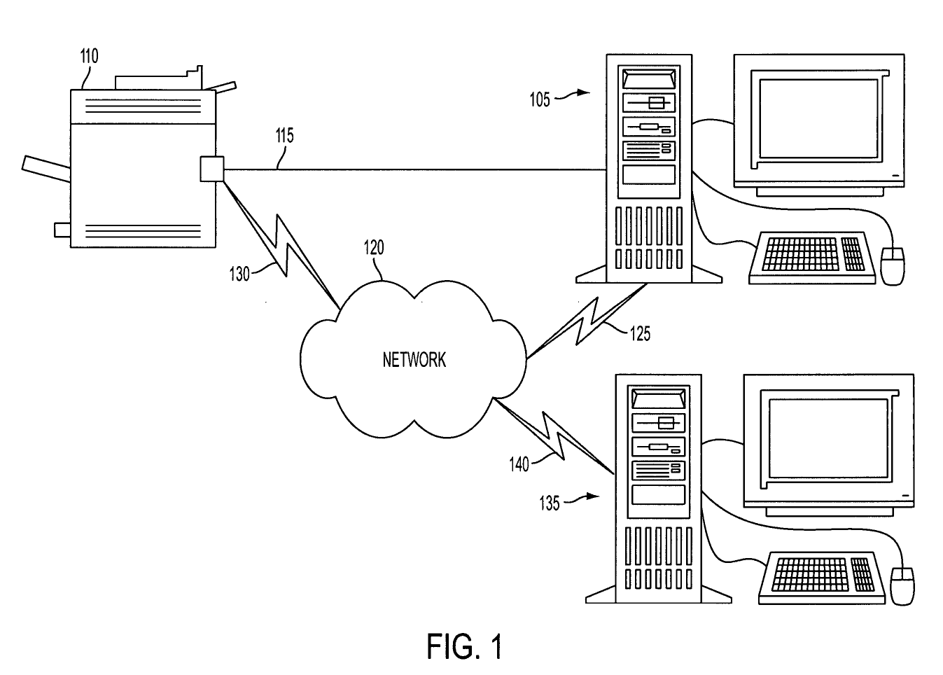

FIG. 1 shows a computer system and a device communicating via multiple communication media, according to an embodiment. In FIG. 1, computer system 105 is shown as including a computer, a monitor, a keyboard, and a mouse. Although computer system 105 is not shown as including other components, a person skilled in the art will recognize that computer system 105 can include other computers. In addition, FIG. 1 does not show any of the internal components of the computer but a person skilled in the art will recognize that these components (e.g., processor, memory, etc.) are part of computer system 105.

Connected to computer system 105 is device 110. In FIG. 1, device 110 is shown as a printer, but a person skilled in the art will recognize that device 110 can be any variety of device that supports multiple communication media: for example, a network copier. Device 110 is shown connected to computer system 105 along two communication media. Device 110 is connected to computer system 105 via connection 115, which directly connects device 110 to computer system 105.

Computer system 105 and device 110 are both connected to network 120, along network connections 125 and 130, respectively. Network 120 can be any variety of network, including a local area network (LAN), a wide area network (WAN), a metropolitan area network (MAN), or a global network such as the Internet, among others. In addition, network 120 can be a wired network, can be a wireless network, such as an IEEE 802.5a/b/g/n network, or a Bluetooth network, among others, or can be a combination of any variety of network, wired and wireless.

Also shown is computer system 135, which is connected to network 120 along network connection 140. Computer system 135 is not directly connected to device 110, but can access device 110 via network 120.

In one embodiment, connection 115 is a Universal Serial Bus (USB) connection, and network connections 125, 130, and 140 are HTTP connections (more specifically, connections 125, 130, and 140 are connections that use TCP/IP protocols to transmit packets that contain HTTP data). Because different connections can require specific connectors, computer systems 105 and 135 and device 110 can all include the appropriate connectors, making the various connections possible. For example, in an embodiment where computer system 105 and device 110 communicate via a USB connection and computer system 135 and device 110 communicate via an HTTP connection, computer system 105 includes a USB connector, computer system 605 includes a network connector (such as an RJ45 connector for an Ethernet connection, or a wireless network card for a wireless network connection, among other possibilities), and device 110 includes the appropriate connectors to receive the other ends of the communication medium. Connection 115 and network connections 125, 130, and 140 correspondingly become a USB cable and network cables (for a wired connection: for wireless connections, network connections 125, 130, and 140 have no tangible structure beyond the wireless connectors). While this example discusses computer system 105 and device 110 communicating via USB and computer system 135 and device 110 communicating via HTTP, a person skilled in the art will recognize that embodiments are not limited to USB and HTTP connections, and will recognize the appropriate mediums to be used for connection 115 and network connections 125, 130, and 140.

While FIG. 1 shows two different communications media that can be used to communicate with device 110, a person skilled in the art will recognize that any number of communication media can be used to reach device 110, and that these communication media can be either direct or via a network. In addition, while FIG. 1 shows only one computer system connected to one device, a person skilled in the art will recognize that there can be any number of computer systems and devices connected in any desired configuration. The remainder of this discussion will center on the embodiment shown in FIG. 1, with one computer system and one device, but a person skilled in the art will recognize how the discussion can be applied to any multi-computer system and/or multi-device embodiment.

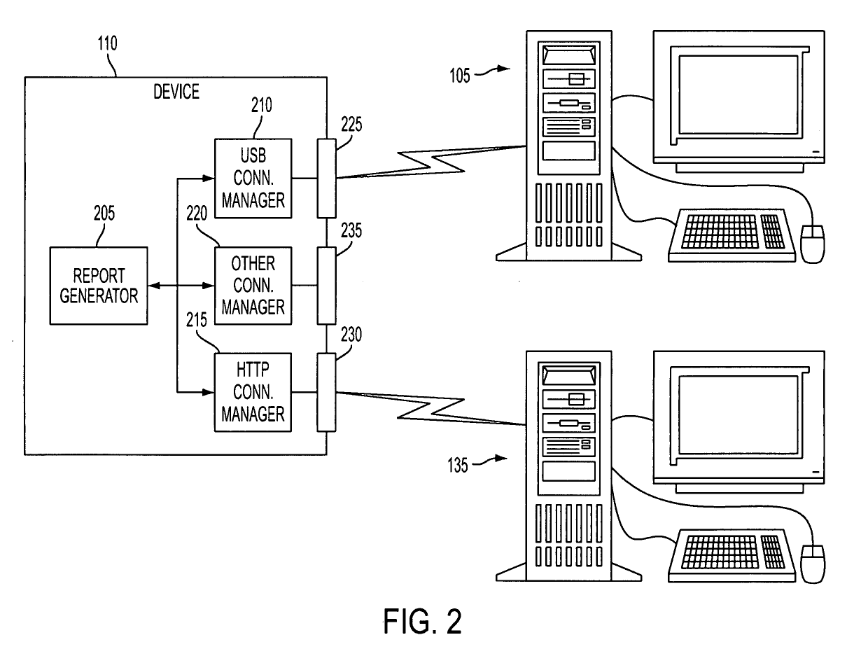

FIG. 2 shows detail of the device of FIG. 1, according to an embodiment. In FIG. 2, device 110 is shown as including report generator 205. Report generator is responsible for generating reports responsive to messages. For example, if the message is a status inquiry, report generator 205 can generate a status report.

A person skilled in the art will recognize that the report prepared by report generator 205 can be generated independently of the communication medium. That means that the contents and structure of the message can be independent of the medium the message is transported across. In one embodiment, the message uses eXtensible Markup Language (XML) to store the information, but a person skilled in the art will recognize that any structure can be used to store the information in the message. Similarly, the messages sent to device 110 can have similar or identical content, even though packaged for transmission along different media. Thus, for example, a status inquiry can be sent along any communication medium, and can be understood by the receiving connection manager to be a status inquiry, even though sent along different communication media, and therefore packaged differently.

One reason for using a structure such as XML is that it decouples the content of the report from the communication medium. For example, within the limits of the hierarchical structure of XML, XML tags can be placed anywhere within the message, without requiring any particular order. (The hierarchical structure of XML supports the use of tags nested within other tags. For tags that are expected to be nested within other tags, the internal tags should not be placed at other levels of the hierarchy. But among tags at the same hierarchical level, the tags can be placed in any order.) With the content of a report being independent from the communication medium over which the report is to be transmitted, report generator 205 does not have to consider the form in which the report will be transmitted. For example, if device 110 is a printer and one of the tags in the report includes the number of pages printed to date, report generator is not obligated to put that page count in, say, bytes 43-44 of the report to avoid errors in the eventual processing of the report.

In addition, report generator 205 can operate without having to understand the content of the report. For example, a component of device 110 might generate an error message. Report generator 205 can add the error message to the report without having to understand what the error message means, or include the error message in a particular bit sequence within the report. Instead, report generator 205 simply adds the appropriate information to the report. Again, when report generator 205 generates reports using XML, report generator 205 simply adds the appropriate tags and values to the report, and can place the error message anywhere in the report.

Another way to look at report generator 205 is to interpret report generator 205 as not having to understand the content of the report at compile time. If the interpretation of a report depends on a particular error message being placed in a specific series of bits within the report, then report generator 205 has to know this in advance. But this means that report generator 205 has to be able to understand how to read a report at compile time. Generating the report in a form that is not so limited frees report generator 205 from having to understand the format of the report. In other words, using message structures such as XML avoid assigning specific meaning to individual bits in the message.

The above discussion is not to say that report generator 205 can arbitrarily format the data in any desirable manner. For example, if the interpretation of a particular tag depends on the data being numeric data, report generator 205 should not start putting text data instead (e.g., the textual equivalent of the number, such as “forty” instead of “40”). But report generator 205 is free to put that particular tag and value information anywhere within the report, as XML does not require tags to be placed in a specific order. (Of course, if it is desirable for an embodiment to add tags to the report in a particular order, report generator 205 can then be designed to put the tags in the expected order.)

There is yet another advantage to an embodiment that uses a structure, like XML, that is independent of the communication medium. When a message uses an encoding that packs the information and interprets a particular bit to have a particular meaning, both the computer and the device need to know how to generate and interpret such encodings. If the encoding is dependent on the communication medium used to transmit the message, the computer and the device need to know how to generate and interpret multiple encodings, which increases complexity (since any change to the data to be transmitted might have to be propagated to each encoding). By using a structure like XML that is independent of the medium (and also independent of the protocol), the computer and the device both only need to know how to interpret one structure: in the example embodiment, XML.

While report generator 205 is not concerned with the communication medium, the medium still plays a part in the transmission of the report to the computer system. Connection managers 210, 215, and 220 handle the communication using a particular communication medium. For example, USB connection manager 210 is responsible for handling communications using a USB connection, and HTTP connection manager 215 is responsible for handling communications over a TCP/IP connection. While USB and HTTP connections are particularly discussed, a person skilled in the art will recognize that there can be any number of different communication media. Other communication media can be managed by other connection managers, such as “other” connection manager 220. “Other” connection manager 220 is a stand-in for all other connection managers, but is not intended to represent a single connection manager handling communications over all other communication media. (Of course, nothing prevents an embodiment from having one connection manager manage communications over several communication media: a person skilled in the art will recognize how to modify a connection manager to support such an embodiment.)

Each connection manager is shown connected to a port. Specifically, USB connection manager 210 is connected to port 225, HTTP connection manager 215 is connected to port 230, and “other” connection manager 220 is connected to port 235. Each port supports communications over the expected communication media. Thus, port 225 can be a USB port, and port 230 can be an RJ45 plug for a network cable (if a wired connection) or a wireless antenna (if a wireless connection). If a single connection manager supports communication over multiple communication media, then obviously the connection manager can be connected to multiple ports: a person skilled in the art will recognize how this can be accomplished.

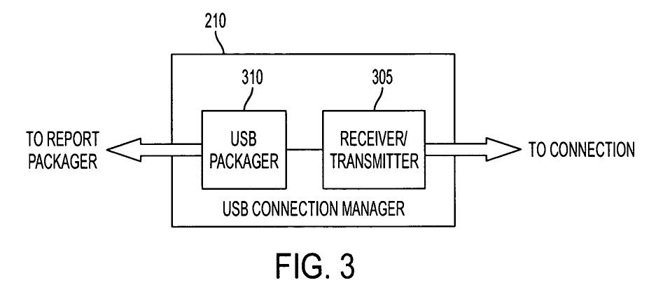

To manage communications, each connection manager interfaces with both the port and report generator 205. FIG. 3 shows how this can be accomplished. In FIG. 3, USB connection manager 210 is shown in greater detail, but a person skilled in the art will recognize that similar components can be used for other connection managers.

USB connection manager includes receiver/transmitter 305 and USB packager 310. Receiver/transmitter is responsible for receiving and transmitting messages across the communication media and to/from the report generator. USB packager 310 is responsible for packaging messages for transmission across the communication media. More specifically, after report generator prepares a report (which, as discussed above, is independent of the communication medium), USB packager 310 prepares the report for transmission along the USB communication medium. This can involve dividing the report into appropriately sized packets for transmission, adding appropriate header information, and so on. In other words, USB packager 310 is not concerned with the content, but rather with formatting the content in a manner that is appropriate for transmission across the USB communication medium. Packagers for other connection managers operate in similar manners, preparing the report for transmission over the respective communication media.

If the number of messages that can be received by a connection manager is fairly limited, then once a connection manager receives a message, it can simply notify the report generator of the type of message received. If more complex messages are to be supported, then the packager can also be used to “unpack” the message for forwarding to the report generator. For example, in FIG. 3, USB packager 310 can be used to “unpack” a message from the computer system into a form that the report generator can process. This enables support for more complicated messages than the simple short messages that can convey content to the report generator in a simple bit sequence.

At this point, a person skilled in the art will recognize that an embodiment can be implemented entirely in software: for example, as code stored in some medium (such as RAM, ROM, or firmware, among other possibilities) and that can be executed on processors within computer systems 105 and 135 and device 110. The hardware shown in FIGS. 1-2 can all be preexisting hardware, which is not modified (except to store and execute the appropriate software). But a person skilled in the art will also recognize that hardware embodiments are also possible. For example, a dedicated hardware apparatus can be designed and installed within device 110 to enable device 110 to receive the message and assemble, package, and transmit the response.

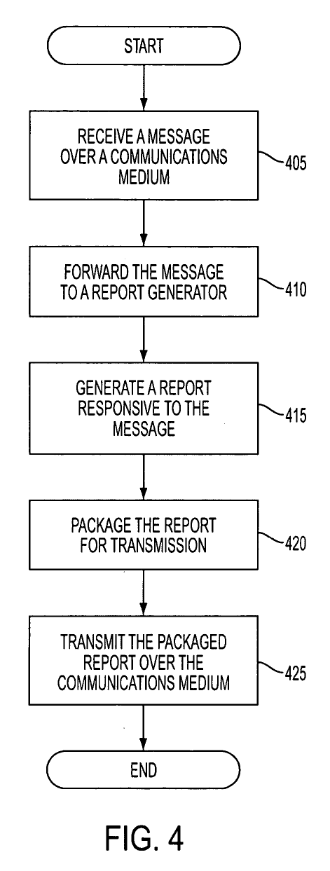

FIG. 4 shows a flowchart of the procedure for communicating between the computer and the device of FIG. 1, according to an embodiment. In FIG. 4, at step 405, the device receives a message over a communications medium. For example, the message might be, without limitation, a status inquiry. As should be apparent, the message is received at the appropriate connection manager for the communication medium, and not at the report generator. At step 410, the message is forwarded to a report generator. At step 415, the device generates a report responsive to the message. This involves informing the report generator of the type of message, so that the report generator can prepare the report. At step 420, the device packages the report for transmission over the communication medium. This involves the report being returned to the connection manager which originally received the message. Finally, at step 425, the device transmits the report, as packaged.

In the above-described embodiments, reports are transmitted over the same communication medium from which the original message was received. But a person skilled in the art will recognize that no such limitation is to be implied to any embodiment. For example, in one embodiment, the message might specify a different communication medium over which the report is to be generated. In such an embodiment, the report is forwarded, not to the connection manager, which received the original message, but rather the connection manager for the specified communication medium.

It will be appreciated that various of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. An apparatus, comprising:
a first connector that can be connected to a first communication medium;
a first connection manager to receive a first message from the first connector, forward the first message to the report generator, receive a first report from the report generator, and transmit the first report across the first connector; and
a second connector that can be connected to a second communication medium;
a second connection manager to receive a second message from the first connector, forward the second message to the report generator, receive a second report from the report generator, and transmit the second report across the first connector; and
a report generator to generate the first report responsive to the first message and the second report responsive to the second message, the first report independent of the first communication medium, and the second report independent of the second communication medium.

2. An apparatus according to claim 1, wherein:
the first connector is a USB connector that can be connected to a USB medium; and
the second connector is a network connector that can be connected to a network.

3. An apparatus according to claim 1, wherein:
the first connection manager includes a first packager to package the first report for transmission across the first connector; and
the second connection manager includes a second packager to package the second report for transmission across the second connector.

4. An apparatus according to claim 1, wherein the report generator is operative to generate the first report and the second report using extensible Markup Language (XML).

5. An apparatus according to claim 1, wherein the report generator is operative to generate the first report and the second report independent of the first communication medium and the second communication medium.

6. An apparatus according to claim 1, wherein:
a content of the first message is identical to a content of the second message; and
a content of the first report is identical to a content of the second report.

7. A system, comprising:
a first communication medium;
a second communication medium;
a device, including:
a first connector that can be connected to the first communication medium;
a first connection manager to receive a first message from the first connector, forward the first message to the report generator, receive a first report from the report generator, and transmit the first report across the first connector; and
a second connector that can be connected to the second communication medium;
a second connection manager to receive a second message from the second connector, forward the second message to the report generator, receive a second report from the report generator, and transmit the second report across the second connector; and
a report generator to generate the first report responsive to the first message and the second report responsive to the second message, the first report independent of the first communication medium, and the second report independent of the second communication medium;
a first machine, including:
a third connector connected to the first communication medium;
a first transmitter to transmit the first message to the device across the third connector; and
a first receiver to receive the first report from the device across the third connector; and
a second machine, including:
a fourth connector connected to the second communication medium;
a second transmitter to transmit the second message to the device across the fourth connector; and
a second receiver to receive the second report from the device across the fourth connector.

8. A system according to claim 7, wherein:
the first communication medium is a USB medium;
the first connector is a first USB connector;
the third connector is a second USB connector;
the second communication medium is a network medium;
the second connector is a first network connector; and
the fourth connector is a second network connector.

9. A system according to claim 7, wherein:
the first connection manager includes a first packager to package the first report for transmission across the first connector; and
the second connection manager includes a second packager to package the second report for transmission across the second connector.

10. A system according to claim 7, wherein the report generator is operative to generate the first report and the second report using eXtensible Markup Language (XML).

11. A system according to claim 7, wherein the report generator is operative to generate the first report and the second report independent of the first communication medium and the second communication medium.

12. A system according to claim 7, wherein the second machine is the first machine.

13. A system according to claim 7, wherein:
a content of the first message is identical to a content of the second message; and
a content of the first report is identical to a content of the second report.

14. A method for a device to respond to a message, comprising:
receiving the message over a communication medium;
generating a report responsive to the message, the report formed independently of the communication medium;
packaging the report for transmission over the communication medium; and
transmitting the report over the communication medium.

15. A method according to claim 14, wherein:
receiving the message over a communication medium includes receiving the message over a USB medium;
packaging the report includes packaging the report for transmission over the USB medium; and
transmitting the report includes transmitting the report over the USB medium.

16. A method according to claim 14, wherein:
receiving the message over a communication medium includes receiving the message over a network medium;
packaging the report includes packaging the report for transmission over the network medium; and
transmitting the report includes transmitting the report over the network medium.

17. A method according to claim 14, wherein generating a report includes generating the report in eXtensible Markup Language (XML).

18. A computer-readable medium containing instructions that, when executed by a machine, result in the method of claim 14.
